(19) United States
(12) Patent Application Publication
(10) Pub. No.: US 2023/0215614 A1
(43) Pub. Date: Jul. 6, 2023

(54) IRON CORE STRUCTURE IN TRANSFORMER AND VOLTAGE CONVERTER

(71) Applicant: Fulian Precision Electronics (Tianjin) Co., LTD., Tianjin (CN)

(72) Inventors: KAI-FU CHEN, New Taipei (TW); CHIA-YUN LEE, New Taipei (TW); KUEI-CHIH HOU, New Taipei (TW)

(21) Appl. No.: 17/708,154

(22) Filed: Mar. 30, 2022

(30) Foreign Application Priority Data
Dec. 30, 2021 (CN) 202111656711.0

(51) Int. Cl. H01F 27/26; H01F 27/30

(52) U.S. Cl. CPC H01F 27/263; H01F 27/306

(57) ABSTRACT

An iron core structure in a transformer which can show different leakage inductance values between primary and secondary windings includes an iron core, and the primary and secondary windings. A first core member of the iron core includes first and second side legs on either side of a first center leg, a second core member butted against the first includes third and fourth side legs on either side of a second center leg. The primary winding is arranged on the center leg, and the secondary winding is arranged on the side legs. The first and third side legs define a gap therebetween, there is a second gap defined between second and fourth side legs. Effective magnetic resistance of the side legs is increased, the primary and secondary windings show different leakage inductance values, and can meet diversified needs of power stage control circuits.

### FIELD

The subject matter herein relates to an iron core structure and a voltage converter having the same.

### BACKGROUND

With the development of science and technology industry, most of the design and R & D objectives of various electronic products and parts are energy saving, stability and efficiency. Among them, transformer is a very important part in supply of electrical power. In more detail, transformer changes the supply voltage. There are step-up transformer, step-down transformer, and special transformer, according to its purpose. Moreover, the transformer is mainly composed of a base, a group of primary coils, a group of secondary coils, and an iron core group.

When current passes through the transformer, the magnetic field of its iron core group will gradually reach saturation, resulting in its output power not only not reaching the expected output power, but also, if continued, raising the overall temperature too much. To reduce overheating, existing iron core structure (referring to FIG. 6) is composed of a first core 11′ and a second core 12′; An air gap 13′ is arranged between the central leg of the first core 11′ and the central leg of the second core 12′, and the primary winding 20′ and the secondary winding 30′ are wound on the central leg of the first core 11′ and the second core 12′ respectively. The air gap 13′ effectively prevents magnetic saturation and improves the stability of the transformer during operation.

Although iron core structure 100′ can prevent magnetic saturation, the equivalent leakage inductance of the primary winding 20′ and the secondary winding 30′ in the existing structure remains basically the same. When the primary winding and the secondary winding need to show different leakage inductance values in a practical application circuit, the existing iron core structure cannot meet the different requirements of the power stage control circuit.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an iron core structure of a transformer in an embodiment according to the present disclosure.

FIG. 2 is a schematic view of a simple air-gap magnetic circuit in the structure of FIG. 1.

FIG. 3 is a schematic view of magnetic lines in the iron core structure of FIG. 1.

FIG. 4 is a schematic diagram of an equivalent reluctance model of the iron core structure of FIG. 1.

FIG. 5 is a schematic diagram of a voltage converter in an embodiment according to the present disclosure.

FIG. 6 is a schematic view of an iron core structure of prior art.

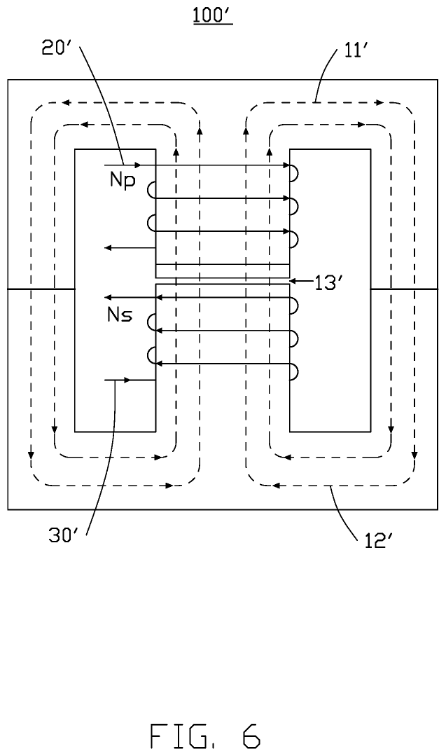

### DESCRIPTION OF MAIN COMPONENTS OR ELEMENTS

Iron core structure 100, 100′;
Iron core 10;
First core member 11, 11′
First center leg 111;
First side leg 112;
Second side leg 113;
First connecting portion 114;
Second core member 12, 12′;
Second center leg 121;
Third side leg 122;
Fourth side leg 123;
Second connecting portion 124;
First gap 13;
Second gap 14;
Air gap 13′
Primary winding 20, 20′;
Secondary winding 30, 30′;
First secondary winding 31;
Second secondary winding 32;
Voltage converter 200;
Power stage control circuit 201.

### DETAILED DESCRIPTION

In order to make the above-mentioned objects, features, and advantages of the present disclosure more obvious, a description of specific embodiments of the present disclosure will be described with reference to the accompanying drawings. The present disclosure can be implemented in many ways different from those described herein, and those skilled in the art can make similar improvements without violating the contents of the present disclosure. Therefore, the present disclosure is not to be considered as limiting the scope of the embodiments to those described herein.

Several definitions that apply throughout this disclosure will now be presented.

Unless otherwise defined, all technical and scientific terms used herein have the same meaning as commonly understood by one skilled in the art. The terms used in the present disclosure herein are only for describing specific embodiments, and are not intended to limit the present disclosure.

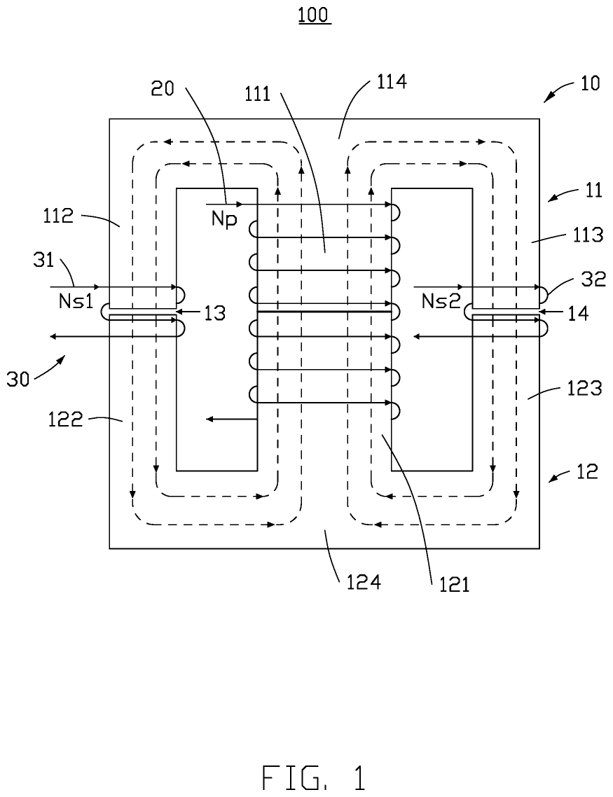

Referring to FIG. 1, in an embodiment of the present disclosure, an iron core structure 100 includes an iron core 10, a primary winding 20, and a secondary winding 30. The primary winding 20 and the secondary 30 twisted around the iron core 10.

The iron core 10 includes a first core member 11 and a second core member 12. The first core member 11 includes a first center leg 111, a first side leg 112, a second side leg 113, and a first connecting portion 114. The first center leg 111, the first side leg 112, and the second side leg 113 are spaced apart from each other, and are connected integrally to the first connecting portion 114. The first side leg 112 and the second side leg 113 are at opposite sides of the first center leg 111. The second core member 12 includes a second center leg 121, a third side leg 122, a fourth side leg 123, and a second connecting portion 124. The second center leg 121, the third side leg 122, and the fourth side leg 123 are spaced apart from each other, and are integrally connected to the second connecting portion 124. The third side leg 122 and the fourth side leg 123 are on opposite sides of the second center leg 121.

An end of the first center leg 111 is connected to an end of the second center leg 121. An end of the first side leg 112 is spaced from an end of the third side leg 122, and a first gap 13 is formed between the first side leg 112 and the third side leg 122. An end of the second side leg 113 is spaced from an end of the fourth side leg 123, and a second gap 14 is formed between the second side leg 113 and the fourth side leg 123.

The primary winding 20 is positioned on the first center leg 111 and the second center leg 121. Specifically, the primary winding 20 is wound on a connecting portion between the first center leg 111 and the second center leg 121. The secondary winding 30 includes a first secondary winding 31 and a second secondary winding 32. The first secondary winding 31 is arranged around the first side leg 112 and the third side leg 122, and the first secondary winding 31 is wound over the first gap 13. The second secondary winding 32 is arranged around the second side leg 113 and the fourth side leg 123, and the second secondary winging 32 is wound over the second gap 14.

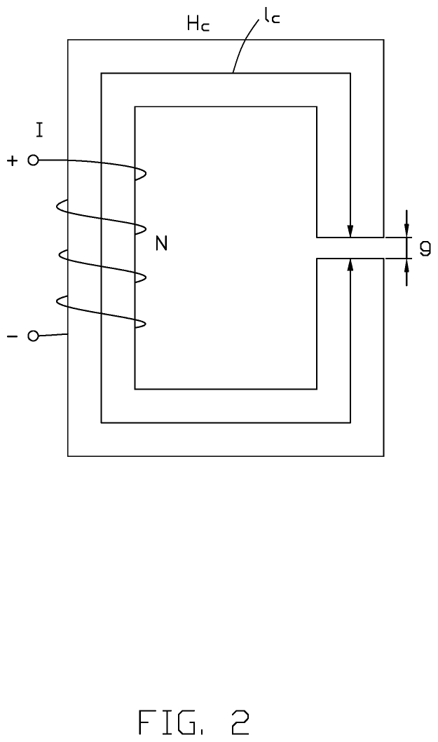

Referring to FIG. 2, FIG. 2 is a schematic view of a simple air-gap magnetic circuit. According to Ampere's Law:

N*I=H*lₘ

Wherein, N is the number of coils of the winding in FIG. 2; I is a current in the coil, H is a magnetic field intensity, and lₘ is a total magnetic circuit length. In the simple air-gap magnetic circuit shown in FIG. 2, lₘ is equal to the sum of a length of magnetic circuit of iron core l_{c} and air gap magnetic circuit length l_{g}, that is:

lₘ=l_{c}+l_{g} (formula (1))

Then a derived formula can be:

N*I=H_{c}*l_{c}+H_{g}*l_{g} (formula (2))

Wherein, H_{c} is a magnetic field intensity of the iron core, and H_{g} is a magnetic field intensity of the air gap.

Formula between the magnetic field intensity H and the magnetic flux density B is:

$$H = \frac{B}{u} , B = u * H \qquad ( formula ( 3 ) )$$

Therefore, an equation of the magnetic field intensity H_{c} and the magnetic field intensity H_{g} is:

$${H}_{C} = \frac{{B}_{C}}{{u}_{c}} , {H}_{g} = \frac{{B}_{g}}{{u}_{o}} \qquad ( equations ( 1 ) , ( 2 ) )$$

Then a derived formula can be:

$$N * I = ( \frac{{B}_{C}}{{u}_{c}} ) * {l}_{c} + ( \frac{{B}_{g}}{{u}_{o}} ) * {l}_{g} \qquad ( formula ( 4 ) )$$

Equation between the magnetic flux density B, and the magnetic flux φ, and magnetic flux area A is:

$$B = \frac{φ}{A} \qquad ( equation ( 3 ) )$$

Furthermore:

$$N * I = ( \frac{{φ}_{C}}{{u}_{c} * {A}_{c}} ) * {l}_{c} + ( \frac{{φ}_{g}}{{u}_{o} * {A}_{g}} ) * {l}_{g} \qquad ( equation ( 4 ) )$$

A transformation equation is:

$$N * I = ( \frac{{l}_{C}}{{u}_{c} * {A}_{c}} ) * {φ}_{c} + ( \frac{{l}_{g}}{{u}_{o} * {A}_{g}} ) * {φ}_{g} \qquad ( equation ( 5 ) )$$

Equations of magnetic reluctance of the iron core R_{C} and magnetic reluctance of the air gap R_{g} are:

$${R}_{C} = \frac{{l}_{C}}{{u}_{c} * {A}_{c}} ; {R}_{g} = \frac{{l}_{g}}{{u}_{o} * {A}_{g}} \qquad ( equations ( 6 ) , ( 7 ) )$$

Therefore, a derived formula is:

N*I=R_{C}*φ_{c}+R_{g}*φ_{g} (formula (5))

In the same magnetic circuit, the magnetic flux of the iron core is same as the magnetic flux of the air gap, and equations are.

φ_{c}=φ_{g} (equation (8))

N*I=(R_{C}+R_{g})*φ (equation (9))

Therefore, it can be concluded that when the number of coils N and current I are constant, defining an air gap in the iron core will increase the magnetic reluctance in the magnetic circuit and reduce the magnetic flux φ.

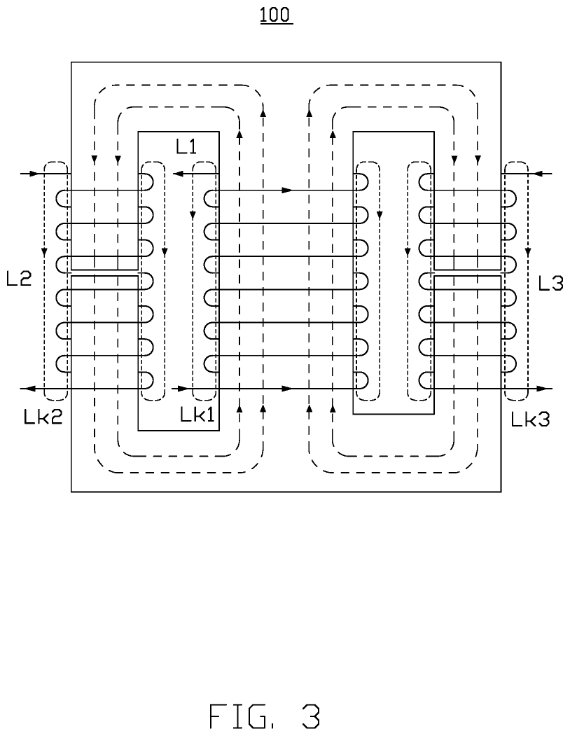

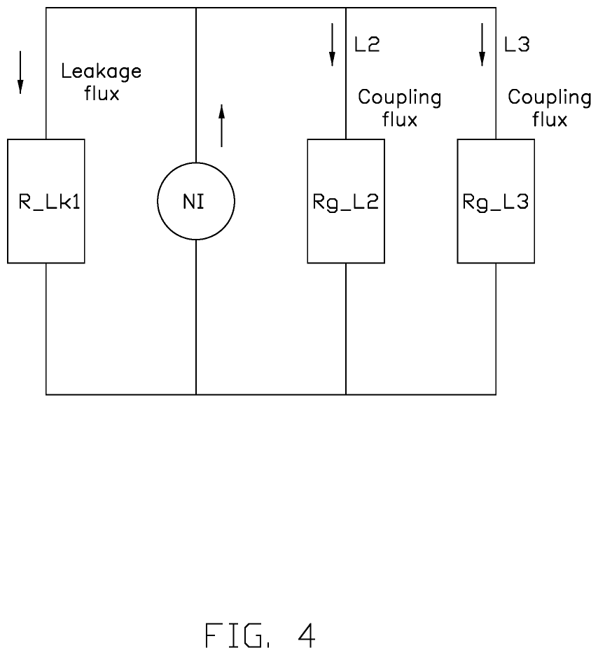

FIG. 3 is a schematic diagram of magnetic lines in the iron core structure 100, and FIG. 4 shows an equivalent reluctance model of the iron core structure 100. Wherein, L1, L2, and L3 represent coupling fluxes at the primary winding 20, the first secondary winding 31, and the second secondary winding 32 respectively. Lk1, Lk2, and Lk3 represent flux leakages at the primary winding 20, the first secondary winding 31, and the second secondary winding 32 respectively. NI represents a magnetomotive force generated by the primary winding 20. R_LK1 represents an equivalent reluctance of the leakage flux of the primary winding 20. Rg_L2 represents an equivalent magnetic resistance of the first gap 13, the first side leg 112, and the third side leg 122. Rg_L3 represents an equivalent magnetic resistance of the second gap 14, the second side leg 113, and the fourth side leg 123.

Defining the first gap 13 and the second gap 14 on side legs positioned on two opposite sides of the center leg can increase a magnetic resistance of side legs, reduce the magnetic beam flowing through the first secondary winding 31 and the second secondary winding 32. Therefore, leakage inductance value of the primary winding 20 can be increased, and leakage inductance value of the secondary winding 30 can be reduced, and make the primary winding 20 and the secondary winding 30 show different leakage inductance values, so as to meet the diversified needs of power stage control circuits. For example, in some circuits, the primary winding 20 can accept (equivalent absorption) large leakage inductance (such as resonance circuit), while the secondary winding 30 side is a hard switching circuit. The reduction of leakage inductance of the secondary winding 30 can reduce a spike voltage during switching, and improve the safety of the circuit.

Additionally, since the secondary winding 30 is arranged around the air gap, a large magnetic potential difference is formed near the air gap, and magnetic potential difference of other positions of the magnetic circuit is small, which can make a good coupling of magnetic flux between the primary winding 20 and the secondary winding 30.

By adjusting the coils ratio of the two windings and the size of the first gap 13 and the second gap 14, different leakage inductance values can be obtained on the primary winding 20, and different proportional combinations of self-inductance and leakage inductance values can be shown on the primary winding 20 and the secondary winding 30 to meet the needs of different power stage control circuits.

Referring to FIG. 1, in an embodiment of the present disclosure, the first side leg 112 and the second side leg 113 are symmetrically arranged on opposite sides of the first center leg 111. The structure of the first core 11 is the same as that of the second core 12, both being an “E” shape. The first side leg 112 and the third side leg 122 are arranged coaxially, and the second side leg 113 and the fourth side leg 123 are arranged coaxially, so that the iron core 10 is symmetrical, which is conducive to equalizing the magnetic field and maintaining good coupling between the primary winding 20 and the secondary winding 30.

Furthermore, a length of the first center leg 111 is greater than lengths of the first and second side legs 112 and 113, similarly the length of second center leg 121 is greater than lengths of third and fourth side legs 122 and 123, so that when the first center leg 111 is connected with the second center leg 121, the first side leg 112 is spaced from the third side leg 122, the second side leg 113 is spaced from the fourth side leg 123, forming the first gap 13 and the second gap 14 on the opposite sides of the iron core 10.

In an embodiment of the present disclosure, the iron core 10 is symmetrical in both upper and lower dimensions. The size of the first gap 13 is the same as that of the second gap 14, which facilitates the uniform distribution of magnetic fields and improves the coupling performance of primary winding 20 and secondary winding 30.

The first gap 13 and the second gap 14 increase the point at which the working magnetic flux density becomes saturated without affecting the original characteristics of the iron core 10. Furthermore, the first gap 13 and the second gap 14 can reduce a residual magnetic field of the iron core 10 when working in asymmetric magnetic field. The larger the gap, the smaller the residual magnetic field of the iron core 10 when coil current drops to zero. Therefore, the iron core 10 of the same volume can output more power. While, the larger the gap, the smaller the inductance coefficient of the iron core 10. In order to achieve a certain inductance, more coils are needed, the related copper loss increases, the number of coils and the distributed capacitance increase relatively, which affects the working stability of the electromagnetic elements. Therefore, the sizes of the first gap 13 and the second gap 14 sizes are set at 1-2 mm in balance. In other embodiments, the sizes of the first gap 13 and the second gap 14 may be less than or greater than 1 mm, and the sizes of the first gap 13 and of the second gap 14 may be different. The number of coils of the first secondary winding 31 and the second secondary winding 32 can also be different and can be adjusted to meet the needs of the actual circuit. For example, in a power stage control circuit, only one secondary winding may be required, and the other secondary winding can be used as auxiliary winding or standby power supply. The size of gaps and the number of coils can be set according to actual requirements, which are not limited in the present disclosure.

In some applications, a cross area of the first center leg 111 is larger than that of the first side leg 112 and the second side leg 113. A cross area of the second center leg 121 is larger than that of the third side leg 122 and the fourth side leg 123, thereby helping to reduce the number of coils in the primary winding 20. A reduced number of coils reduces leakage inductance value of primary winding 20.

Furthermore, the first center leg 111 and the second center leg 121 may be welded together as well as made integrally.

In other embodiments, a third gap can also be set between the first center leg 111 and the second center leg 111 to further adjust the self-inductance and leakage inductance values of the primary winding 20 and the secondary winding 30.

In an embodiment of the present disclosure, material of the iron core 10 includes, but is not limited to, materials such as silicon steel or ferrites. Material of the secondary winding 30 includes, but is not limited to, copper wire, copper strip, etc.

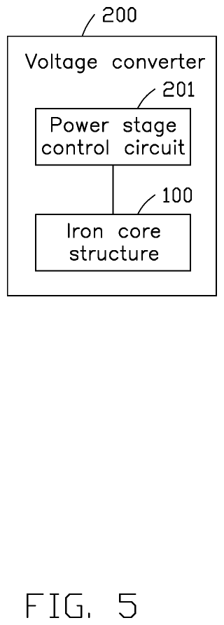

Referring to FIG. 5, the present disclosure further discloses a voltage converter 200, the voltage converter 200 includes a power stage control circuit 201 and the iron core structure 100 described above. The iron core structure 100 is electrically connected to the power stage control circuit 201.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. An iron core structure comprising:
a primary winding;
a secondary winding; and
an iron core, wherein the primary winding and the secondary winding are twisted around the iron core;
wherein the iron core comprises a first core member and a second core member, the first core member comprises a first side leg, a second side leg, and a first center leg spaced apart from the first and the second side legs; the second core member comprises a third side leg, a fourth side leg, and a second center leg spaced apart from the third and the forth side legs;
the first center leg is connected to the second center leg; a first gap is defined between the first side leg and the third side leg; a second gap is defined between the second side leg and the fourth side leg;
the primary winding is positioned on the first center leg and the second center leg;
the secondary winding comprises a first secondary winding and a second secondary winding, the first secondary winding is arranged around the first gap, the second secondary winding is arranged around the second gap.

2. The iron core structure as claimed in claim 1, wherein the first side leg and the second first leg are symmetrically positioned at two opposite sides of the first center leg.

3. The iron core structure as claimed in claim 2, wherein the first side leg is coaxially positioned with the third side leg, the second side leg is coaxially positioned with the fourth side leg.

4. The iron core structure as claimed in claim 3, wherein a length of the first center leg is greater than a length of the first side leg; a length of the second center leg is greater than a length of the third side leg.

5. The iron core structure as claimed in claim 3, wherein a size of the first gap is equal to a size of the second gap.

6. The iron core structure as claimed in claim 3, wherein a cross area of the first center leg is greater than a cross area of the first center leg.

7. The iron core structure as claimed in claim 1, wherein the first center leg and the second center leg are connected in one piece.

8. The iron core structure as claimed in claim 1, wherein sizes of the first gap and the second gap are 1-2 mm.

9. The iron core structure as claimed in claim 1, wherein material of the iron core comprises silicon steel sheet or ferrite.

10. The iron core structure as claimed in claim 1, wherein the first core member further comprises a first connecting portion, the first side leg, the first center leg, and the second side leg are connected to the first connecting portion in one piece; the second core member further comprises a second connecting portion, the third side leg, the second center leg, and the fourth side leg are connected to the second connecting portion in one piece.

11. A voltage converter comprising:
a power stage control circuit; and
an iron core structure electrically connected to the power stage control circuit;
wherein the iron core structure comprises:
a primary winding;
a secondary winding; and
an iron core, wherein the primary winding and the secondary winding twist around the iron core;
wherein the iron core comprises a first core member and a second core member, the first core member comprises a first side leg, a second side leg, and a first center leg spaced apart from the first and the second side legs; the second core member comprises a third side leg, a fourth side leg, and a second center leg spaced apart from the third and the forth side legs;
the first center leg is connected to the second center leg; a first gap is defined between the first side leg and the third side leg; a second gap is defined between the second side leg and the fourth side leg;
the primary winding is positioned on the first center leg and the second center leg;
the secondary winding comprises a first secondary winding and a second secondary winding, the first secondary winding is arranged around the first gap, the second secondary winding is arranged around the second gap.

12. The voltage converter as claimed in claim 11, wherein the first side leg and the second first leg are symmetrically positioned at two opposite sides of the first center leg.

13. The voltage converter as claimed in claim 12, wherein the first side leg is coaxially positioned with the third side leg, the second side leg is coaxially positioned with the fourth side leg.

14. The voltage converter as claimed in claim 13, wherein a length of the first center leg is greater than a length of the first side leg; a length of the second center leg is greater than a length of the third side leg.

15. The voltage converter as claimed in claim 13, wherein a size of the first gap is equal to a size of the second gap.

16. The voltage converter as claimed in claim 13, wherein a cross area of the first center leg is greater than a cross area of the first center leg.

17. The voltage converter as claimed in claim 11, wherein the first center leg and the second center leg are connected in one piece.

18. The voltage converter as claimed in claim 11, wherein sizes of the first gap and the second gap are 1-2 mm.

19. The voltage converter as claimed in claim 11, wherein material of the iron core comprises silicon steel sheet or ferrite.

20. The voltage converter as claimed in claim 11, wherein the first core member further comprises a first connecting portion, the first side leg, the first center leg, and the second side leg are connected to the first connecting portion in one piece; the second core member further comprises a second connecting portion, the third side leg, the second center leg, and the fourth side leg are connected to the second connecting portion in one piece.
